(19) United States
(12) Patent Application Publication
(10) Pub. No.: US 2010/0085942 A1
(43) Pub. Date: Apr. 8, 2010

(54) Communication Control Apparatus and Communication Control Method

(75) Inventors: Yoshikazu Oota, Kanagawa (JP); Kenji Kono, Kanagawa (JP); Koji Narushima, Kanagawa (JP); Makoto Tomizu, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/521,526

(22) PCT Filed: Dec. 26, 2007
(86) PCT No.: PCT/JP2007/075026

§ 371 Date: Dec. 18, 2009

(30) Foreign Application Priority Data
Dec. 27, 2006 (JP) 2006-352806

(51) Int. Cl. H04W 72/04; H04W 36/30

(52) U.S. Cl. 370/332; 370/329

(57) ABSTRACT

There is provided a base station having a resource assigning unit for assigning QoS resources in response to a QoS setting request and a resource securing unit for securing, when a wireless communication terminal that is communicating with a base station by setting a QoS specifies the own base station as a handoff candidate base station, QoS resources by correlating to the wireless communication terminal. The resource assigning unit assigns, in the case where there are no QoS resources available when assigning QoS resources in response to the QoS setting request, the QoS resources that have been secured by the resource securing unit by correlating to the wireless communication terminal to a wireless communication terminal that has transmitted the QoS setting request.

### CROSS REFERENCE TO RELATED APPLICATION

This application claims priority to and the benefit of Japanese Patent Application No. 2006-352806 (filed on Dec. 27, 2006), the entire contents of which are incorporated herein by reference.

### TECHNICAL FIELD

The present invention relates to a communication control apparatus and a communication control method for a mobile terminal communication system.

### BACKGROUND ART

In a mobile terminal communication system using the CDMA (Code Division Multiple Access) scheme, a plurality of schemes have generally been adopted or introduced as a scheme of transmitting data including moving image data transmitted and received by the application such as IP-TV phones. For example, with respect to the CDMA2000, the communication scheme (CDMA2000 1x) that uses a circuit switching, the communication scheme (CDMA2000 1xEV-DO Rev. 0) that realizes a data rate (transmission speed) of 153.6 kbps for upward and approximately 2.4 Mbps for downward by using a packet switching scheme and the communication scheme (CDMA2000 1xEV-DO Rev. A) that realizes a data rate (transmission speed) of approximately 1.8 Mbps for upward and approximately 3.1 Mbps for downward by further speeding up the above-mentioned Rev. 0 transmission scheme are provided as a scheme of transmitting data (see, for example, Non-Patent Documents 1 and 2). In addition, another characteristics of the CDMA2000 1xEV-DO Rev. A is that a function to control QoS (Quality of Service) has been added.

In a mobile terminal communication system exemplified in FIG. 16, a wireless communication terminal (AT: Access terminal) performs handoff to switch a base station (AN: Access Network) of the corresponding party in response to change of pilot signal reception strength (hereinafter referred to as pilot strength). Such handoff includes the handoff between the subordinate base stations (ANs) of the same packet control apparatus (hereinafter referred to as handoff between ANs) and the handoff between the subordinate base stations (ANs) of different packet control apparatuses (PCF: Packet Control Function) (hereinafter referred to as handoff between PCFs). More specifically, the handoff between ANs means that a wireless communication terminal (AT) 10a shown in FIG. 16 performs handoff from a subordinate base station (AN) 21a to a base station (AN) 22a of the same packet control apparatus (PCF) 30a and the handoff between PCFs means that a wireless communication terminal (AT) 10b performs handoff from a subordinate base station (AN) 23a of the packet control apparatus (PCF) 30a to a subordinate base station (AN) 21b of a packet control apparatus (PCF) 30b.

The QoS technology of EV-DO is configured such that a base station assigned to a wireless communication terminal secures QoS resources for the wireless communication terminal in response to a “Traffic Channel Assignment” message. For example, as shown in FIG. 17, in the case where the QoS resource guaranteed wireless communication terminal A moves and goes into in a state where the wireless communication terminal A can communicate with both base stations α and β (hereinafter referred to as the 2Way state), each of the base stations α and β secures QoS resources for the wireless communication terminal A. Normally, a wireless communication terminal goes into the 2Way state when it performs handoff, and under the 2Way state, the wireless communication terminal communicates with only either one of the base stations (in the example shown in the figure, the base station α) specified by “DRC (Data Rate Control bit) Cover”.

Non-Patent Document 1: “cdma2000 High Rate Packet Data Air Interface 3GPP2 C.S0024 Version 4.0”, 3GPP2, October 2002 (Section 8.5.6.1, Section 9.3.1.3.2.3.2)
Non-Patent Document 2: “cdma2000 High Rate Packet Data Air Interface 3GPP2 C.S0024-A Version 2.0”, 3GPP2, July 2005 (Section 13.2.1.3.1.1, Section 13.3.1.3.1.1.)

### SUMMARY OF INVENTION

### Technical Problem

When a wireless communication terminal goes into the 2Way state, the base station with which the wireless communication terminal communicates is only either one of the base stations. Therefore, it is assumed that the QoS resources secured by the base station that does not communicate with the wireless communication terminal is wasted.

Since the QoS resources in a base station is limited, when the number of wireless communication terminals to communicate with increases, it is required for a base station to reduce a QoS rate that is assigned to a wireless communication terminal or not to assign QoS resources.

At first, as shown in FIG. 18, assuming that the wireless communication terminal B makes a new QoS request (rate high) to the base station β when the wireless communication terminal A that is communicating with the base station α at a high QoS rate is in the 2Way state with the base stations α and β, the QoS resource assignment state in this case can be classified into the following three patterns;

Pattern 1 shown in FIG. 19 illustrates the case where the remaining amount of QoS resources in the base station β is enough when the wireless communication terminal B makes the QoS request (rate high). In this case, a high-rate QoS can be assigned to the wireless communication terminal B by executing step S102 following YES in step S101 of the flow chart shown in FIG. 22, and no problem occurs. Here, after step S102, the process moves to step S103 and “a terminal No. and an assigned QoS rate” are registered in a QoS table.
Pattern 2 shown in FIG. 20 illustrates the case where the remaining amount of QoS resources in the base station β is not enough to meet the QoS request (rate high) from the wireless communication terminal B but is enough to meet a QoS request (rate low). In this case, a low-rate QoS can be assigned to the wireless communication terminal B by executing step S105 following YES in step S104 following NO in step S101 of the flow chart shown in FIG. 22. Here, after step S105, the process moves to step S103 and “a terminal No. and an assigned QoS rate” are registered in a QoS table.
Pattern 3 shown in FIG. 21 illustrates the case where the QoS resources in the base station β have been decreased to the amount which is not enough to assign even a low-rate QoS (no QoS resources) in response to the QoS request from the wireless communication terminal B because the QoS resources have been secured for the wireless communication terminal A with which the base station β is not communicating when the wireless communication terminal B makes the QoS request (rate high). Here, the QoS request from the wireless communication terminal B is rejected by executing step S106 following NO in step S104 following NO in step S101 of the flow chart shown in FIG. 22.

In the case of the above-mentioned pattern 2, when the wireless communication terminal B transmits the QoS request to the base station β, the base station β has secured QoS resources for the wireless communication terminal A with which the base station β is not actually communicating. Therefore, the requested QoS resources cannot be secured and a low QoS rate is assigned to the wireless communication terminal B. In the case of the above-mentioned pattern 3, when the wireless communication terminal B transmits the QoS request to the base station β, the base station β has secured QoS resources for the wireless communication terminal A with which the base station β is not actually communicating. Therefore, even a low QoS rate cannot be assigned in response to the requested QoS resources, and the QoS request is rejected.

The first object of the present invention is to provide a communication control apparatus that can improve the use efficiency of QoS resources by reducing QoS resources secured for a wireless communication terminal with which the communication control apparatus is not communicating, in the case where a new QoS request from a wireless communication terminal cannot be met.

The second object of the present invention is to provide a communication control method that can improve the use efficiency of QoS resources by assigning QoS resources secured for a wireless communication terminal with which a communication control apparatus is not communicating to a wireless communication terminal that has transmitted a new QoS request, in the case where a new QoS request from the wireless communication terminal cannot be met.

### Solutions to Problems

In order to achieve the above-mentioned first object, a communication control apparatus in accordance with the present invention comprises:

a resource assigning unit for receiving a QoS setting request and assigning QoS resources in response to the QoS setting request; and

a resource securing unit for securing, when a wireless communication terminal that is communicating with a base station by setting a QoS specifies a handoff candidate base station from the base station, the QoS resources by correlating to the wireless communication terminal, wherein
the resource assigning unit assigns, in the case where there are no QoS resources available when receiving the QoS setting request and assigning the QoS resources in response to the QoS setting request, the QoS resources that have been secured by the resource securing unit by correlating to the wireless communication terminal to a wireless communication terminal that has transmitted the QoS setting request.

In addition, in the communication control apparatus in accordance with an embodiment of the present invention, the resource securing unit secures the QoS resources and assigns a traffic channel as well for the wireless communication terminal that has transmitted the QoS setting request, and does not give notification of information relating to the secured QoS resources thereto.

Further, in the communication control apparatus in accordance with another embodiment of the present invention, when the QoS resources have become available, the resource securing unit secures the QoS resources again by correlating to the wireless communication terminal that is communicating.

Moreover, in the communication control apparatus in accordance with still another embodiment of the present invention, in the case where the QoS resources secured by the resource securing unit by correlating to the wireless communication terminal have been assigned to another wireless communication terminal when the wireless communication terminal having specified the handoff candidate base station initiates a handoff process;

the resource securing unit secures the QoS resources required for the wireless communication terminal to communicate by setting a QoS; and

the resource assigning unit assigns the QoS resources secured by the resource securing unit to the wireless communication terminal.

In order to achieve the above second object, a communication control method in accordance with still another embodiment of the present invention comprises the steps of;

securing QoS resources, when a wireless communication terminal that is communicating with a base station by setting a QoS specifies a handoff candidate base station from the base station, by correlating to the wireless communication terminal; and

assigning, in the case where there are no QoS resources available when a new QoS setting request is received after securing the QoS resources and the QoS resources are assigned in response to the QoS setting request, the QoS resources secured by correlating to the wireless communication terminal that has specified the handoff candidate base station to a wireless communication terminal that has transmitted the new QoS setting request.

### ADVANTAGEOUS EFFECTS ON INVENTION

In accordance with the present invention, assignment of QoS resources secured in a base station for a wireless communication terminal with which a base station is not communicating to another wireless communication terminal that has transmitted a QoS request makes it possible to provide QoS resources that meet the QoS request (high QoS rate) to another wireless communication terminal and to increase the accommodation number of QoS communication terminals in the base station. Thus a communication control apparatus and a communication control method that can improve the use efficiency of QoS resources can be provided.

### BRIEF DESCRIPTION OF DRAWINGS

FIG. 1 is a block diagram showing a configuration of a base station used as a communication control apparatus in a mobile terminal communication system in accordance with the first embodiment of the present invention;

FIG. 2 (a) is a diagram exemplifying a QoS table and (b) is a diagram exemplifying a QoS table used by a communication control apparatus of a mobile terminal communication system in accordance with the first embodiment;

FIG. 3 is a diagram for illustrating an outline of a QoS control process performed by a base station, which is a communication control apparatus, in a mobile terminal communication system in accordance with the first embodiment;

FIG. 4 is a diagram for illustrating pattern 1 of a QoS control process performed by a base station, which is a communication control apparatus, in a mobile terminal communication system in accordance with the first embodiment;

FIG. 5 is a diagram for illustrating pattern 2 of a QoS control process performed by a base station, which is a communication control apparatus, in a mobile terminal communication system in accordance with the first embodiment;

FIG. 6 is a diagram for illustrating pattern 3 of a QoS control process performed by a base station, which is a communication control apparatus, in a mobile terminal communication system in accordance with the first embodiment;

FIG. 7 is a flow chart showing the QoS assignment process performed by a base station, which is a communication control apparatus, in a mobile terminal communication system in accordance with the first embodiment;

FIG. 8 is a flow chart showing the QoS reduction process performed by a base station, which is a communication control apparatus, in a mobile terminal communication system in accordance with the first embodiment;

FIGS. 9 (a) and (b) are diagrams for illustrating an outline of the QoS recovery process 1 performed by a base station, which is a communication control apparatus, in a mobile terminal communication system in accordance with the first embodiment;

FIG. 10 is a flow chart showing the QoS recovery process 1 performed by a base station, which is a communication control apparatus, in a mobile terminal communication system in accordance with the first embodiment;

FIG. 11 a diagram for illustrating an outline of the QoS recovery process 2 performed by a base station, which is a communication control apparatus, in a mobile terminal communication system in accordance with the first embodiment;

FIG. 12 is a diagram for illustrating pattern 1 of the QoS recovery process 2 performed by a base station, which is a communication control apparatus, in a mobile terminal communication system in accordance with the first embodiment;

FIG. 13 is a diagram for illustrating pattern 2 of the QoS recovery process 2 performed by a base station, which is a communication control apparatus, in a mobile terminal communication system in accordance with the first embodiment;

FIG. 14 is a diagram for illustrating pattern 1 of the QoS recovery process 3 performed by a base station, which is a communication control apparatus, in a mobile terminal communication system in accordance with the first embodiment;

FIG. 15 is a flow chart showing the QoS recovery process 2 performed by a base station, which is a communication control apparatus, in a mobile terminal communication system in accordance with the first embodiment;

FIG. 16 is a diagram showing a configuration example of a mobile terminal communication system;

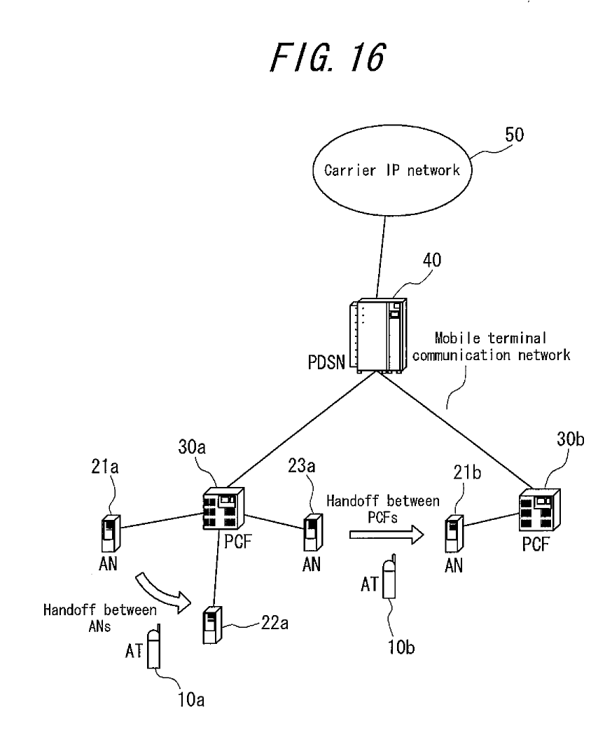

FIG. 17 is a diagram for illustrating securement of QoS resource by two base stations in the case where a wireless communication terminal goes into the 2Way state in a mobile terminal communication system;

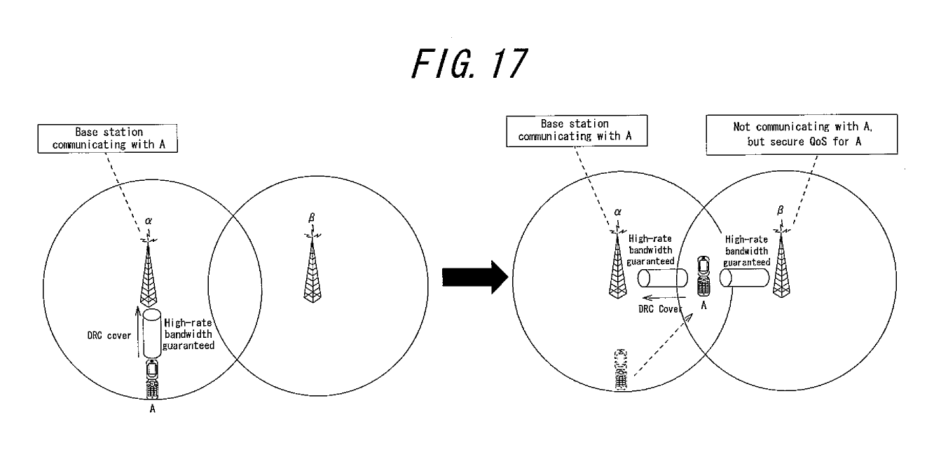

FIG. 18 is a diagram for illustrating the case when a wireless communication terminal which is communicating with a base station at a high QoS rate in a mobile terminal communication system goes into the 2Way state with the base station and another base station, another wireless communication terminal makes a QoS request (rate high) to the another base station;

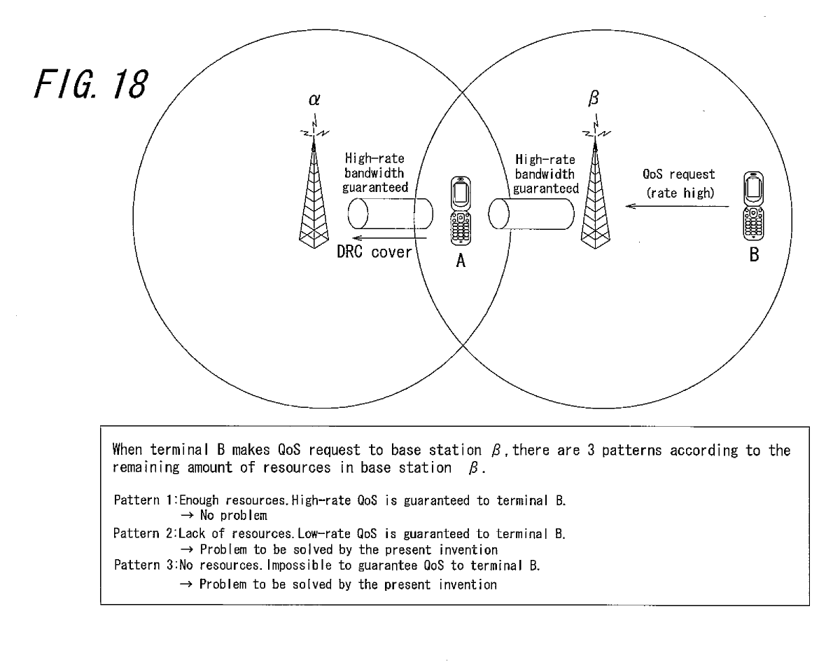

FIG. 19 is a diagram for illustrating pattern 1 of the QoS resource securing state at the time of a QoS request (rate high) of FIG. 18;

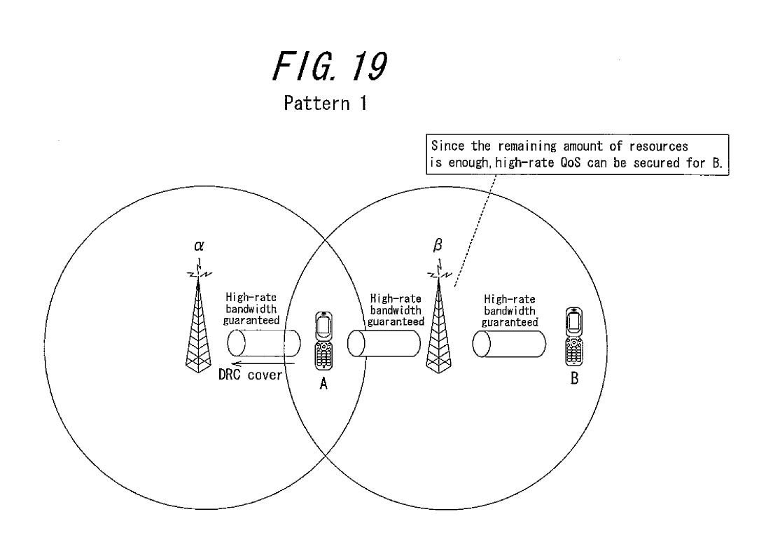

FIG. 20 is a diagram for illustrating pattern 2 of the QoS resource securing state at the time of a QoS request (rate high) of FIG. 18;

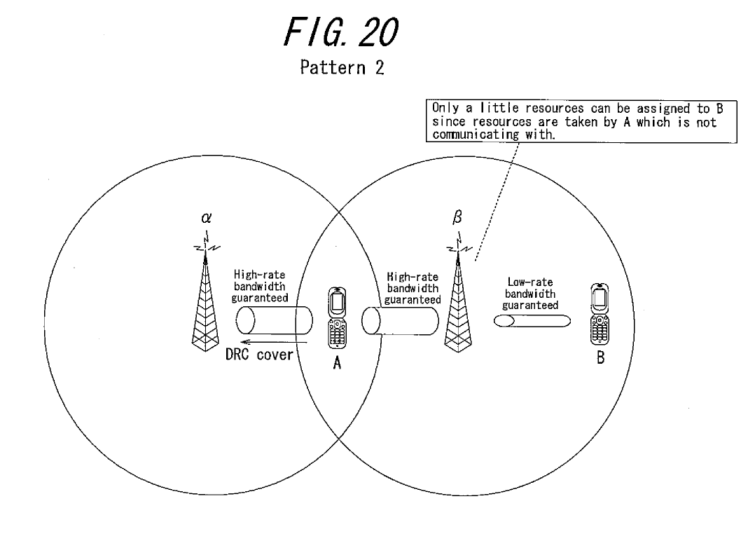

FIG. 21 is a diagram for illustrating pattern 3 of the QoS resource securing state at the time of a QoS request (rate high) of FIG. 18;

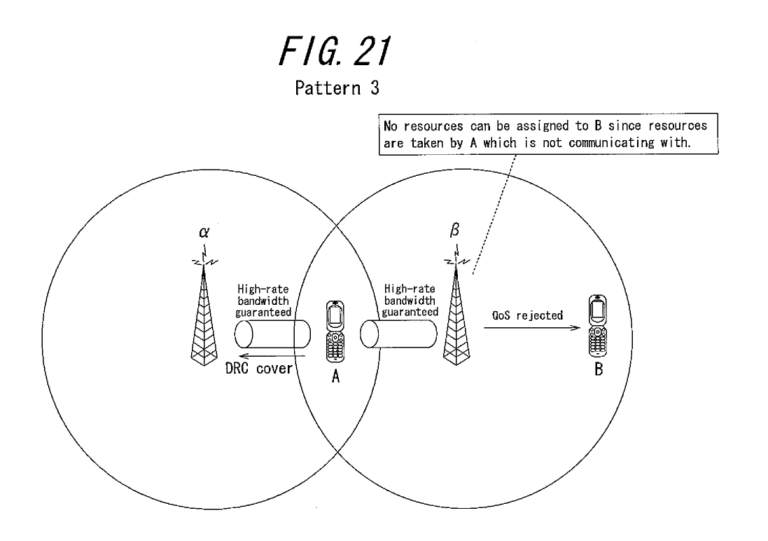

FIG. 22 is a flow chart showing the QoS assignment process performed by a base station, which is a communication control apparatus, in the conventional mobile terminal communication system.

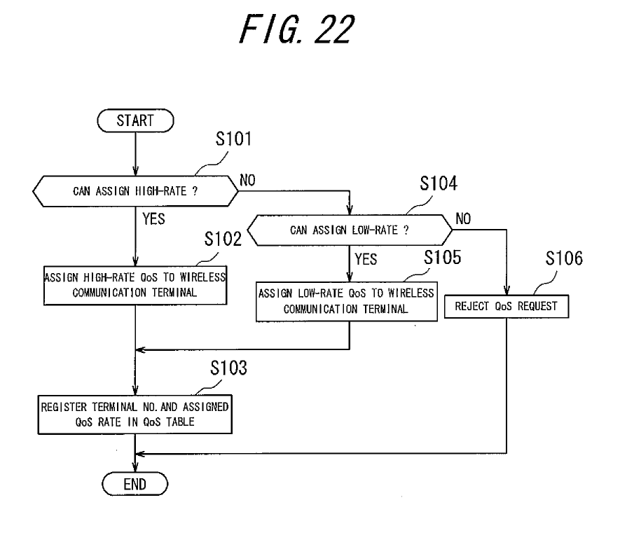

### DESCRIPTION OF THE PREFERRED EMBODIMENTS

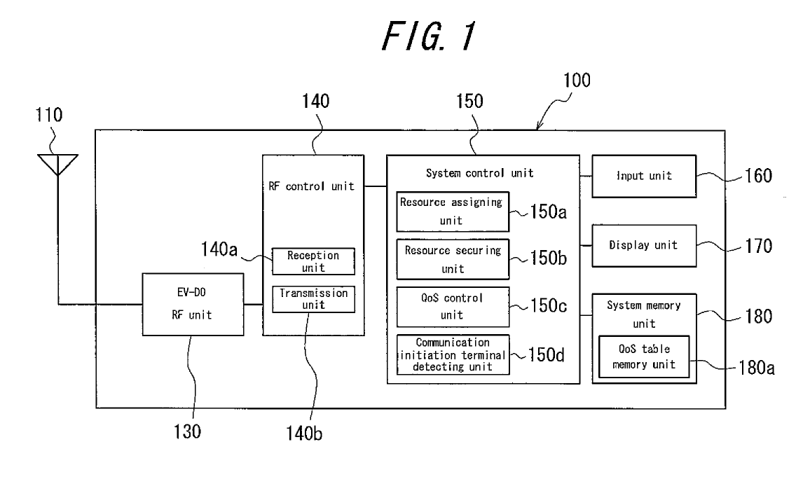

Preferred embodiments of the present invention will now be described below in detail in accordance with the accompanying drawings. FIG. 1 is a block diagram showing a configuration of a base station 100 used as a communication control apparatus in a mobile terminal communication system in accordance with the first embodiment of the present invention. Here, the two base stations 100 are referred to as base stations α and β in the following description. The base station 100 in accordance with the present embodiment is configured so that it can perform data communication with a base station that uses the CDMA2000 1xEV-DO communication scheme (hereinafter referred to as an EV-DO system) by using an antenna 110. The CDMA2000 1xEV-DO communication scheme corresponds to both CDMA2000 1xEV-DO Rev. 0 and CDMA2000 1xEV-DO Rev. A or only to CDMA2000 1xEV-DO Rev. A.

Here, FIG. 1 shows an example that uses a base station as a communication control apparatus, which is a component of the mobile terminal communication system. However, in the case where a packet control apparatus (PCF: Packet Control Function) is used as a communication control apparatus, the process (the QoS resource reduction process or the like) which is unique to the present invention and has been realized in a base station can be realized in the PCF by mounting the equivalent of the configuration and function of the base station described below on the PCF.

The above-mentioned base station 100 has an RF (Radio Frequency) unit 130 for EV-DO, an RF control unit 140, a system control unit 150, an input unit 160, a display unit 170 and a system memory unit 180 or the like in addition to an antenna 110. The RF control unit 140 has a reception unit 140a and a transmission unit 140b. The system control unit 150 has a resource assigning unit 150a, a resource securing unit 150b, a QoS control unit 150c and a communication initiation terminal detecting unit 150d. The system memory unit 180 has a QoS table memory unit 180a.

The above-mentioned RF unit 130 for EV-DO converts the data transmitted from the EV-DO system into a high-frequency signal and transmits it from the antenna 110, and converts the data input from the antenna 110 into a high-frequency signal.

The above-mentioned RF control unit 140 controls the communication (transmission and reception) of the EV-DO system and measures intensity of radio waves (RSSI or the like) received by the antenna from wireless communication terminals and other base station apparatuses (not shown). In addition, the RF control unit 140 serves as the reception unit 140a and the transmission unit 140b of high-frequency signals input from and output to the RF unit 130 for EV-DO, and further, receives a QoS setting request from a wireless communication terminal.

The above-mentioned system control unit 150 is a control unit for collectively controlling each unit of the base station apparatus 100.

The above-mentioned resource assigning unit 150a receives a QoS setting request and assigns QoS resources in response to the QoS setting request. In the case where there are no QoS resources available when assigning QoS resources, the resource assigning unit 150a assigns the QoS resources that has been secured by the resource securing unit 150b by correlating them to a wireless communication terminal that is not communicating with a base station by setting a QoS to a wireless communication terminal that has transmitted the QoS setting request.

When a wireless communication terminal that is communicating with another base station by setting a QoS specifies the own base station as a handoff candidate base station from the another base station, the above-mentioned resource securing unit 150b secures QoS resources by correlating to the wireless communication terminal. The above-mentioned resource securing unit 150b secures QoS resources and assigns a traffic channel as well for a wireless communication terminal that has transmitted a QoS setting request, but does not give notification of the information relating to the secured QoS resources thereto. In addition, when QoS resources become available, the above-mentioned resource securing unit 150b secures the QoS resources by correlating them to a wireless communication terminal that is not communicating with another base station by setting a QoS. Further, the QoS resources that have been eliminated to be assigned to the wireless communication terminal that has transmitted a QoS setting request are secured again, after release of the QoS resources, by correlating to the wireless communication terminal that has secured the QoS resources before the elimination. Moreover, when a wireless communication terminal having specified the own base station as a handoff candidate base station from another base station has initiated the handoff process, if the QoS resources secured by correlating to the wireless communication terminal have been assigned to another wireless communication terminal, the resource securing unit 150b secures QoS resources required for the wireless communication terminal to communicate by setting a QoS.

When the above-mentioned resource assigning unit 150a assigns the QoS resources that have been secured by the above-mentioned resource securing unit 150b for a wireless communication terminal to a wireless communication terminal, the above-mentioned QoS control unit 150c performs QoS resource control to decide the wireless communication terminals to which the QoS resources are assigned between the wireless communication terminal that has secured the QoS resources or another wireless communication terminal.

The above-mentioned communication initiation terminal detecting unit 150d is a wireless communication terminal that is communicating with another base station by setting a QoS and detects that a wireless communication terminal in the 2Way state that having specified the own base station as a handoff candidate base station from another base station has initiated handoff to the own base station for communication. Practically, initiation of communication is detected when “DRC Cover” points toward the own base station.

In addition, the Index value of the DRC Cover is indicated by “1”˜“b” in the case of a base station during communication (which is called sector cover), and indicated by “0” in the case of a handoff candidate base station (which is called null cover). Here, the DRC Index for each base station communicates with a wireless communication terminal based on the Traffic Channel Assignment.

The above-mentioned input unit 160 is used for inputting the information and selecting among options displayed on a display screen of the display unit 170, and has various keys and buttons. The input unit 160 and the display unit 170 may be omitted according to the situation.

The above-mentioned system memory unit 180 is configured by a memory such as RAM and stores application programs and temporal data.

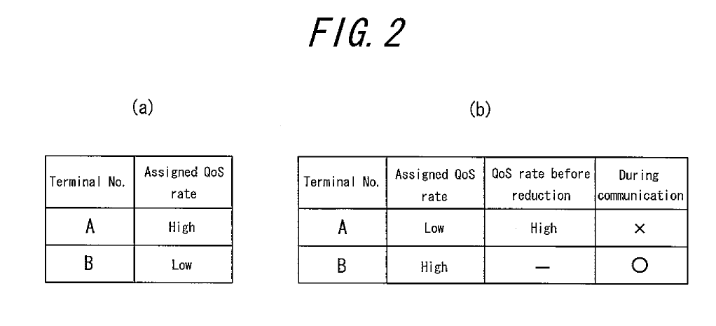

The above-mentioned QoS table memory unit 180a stores QoS tables used for the QoS reduction process and QoS recovery process described below. The QoS table used by the present embodiment is provided with two items of “QoS rate before reduction” and “during communication” as shown in FIG. 2 (b) in addition to two items of “terminal No.” and “assignment QoS rate” as shown in FIG. 2 (a). In “QoS rate before reduction”, a QoS rate before reduction, which is an original QoS rate, is recorded when an assigned QoS rate is reduced by the QoS reduction process, and in “during communication”, whether the DRC Cover points toward the base station is recorded, and is updated when the DRC Cover for the wireless communication terminal is changed.

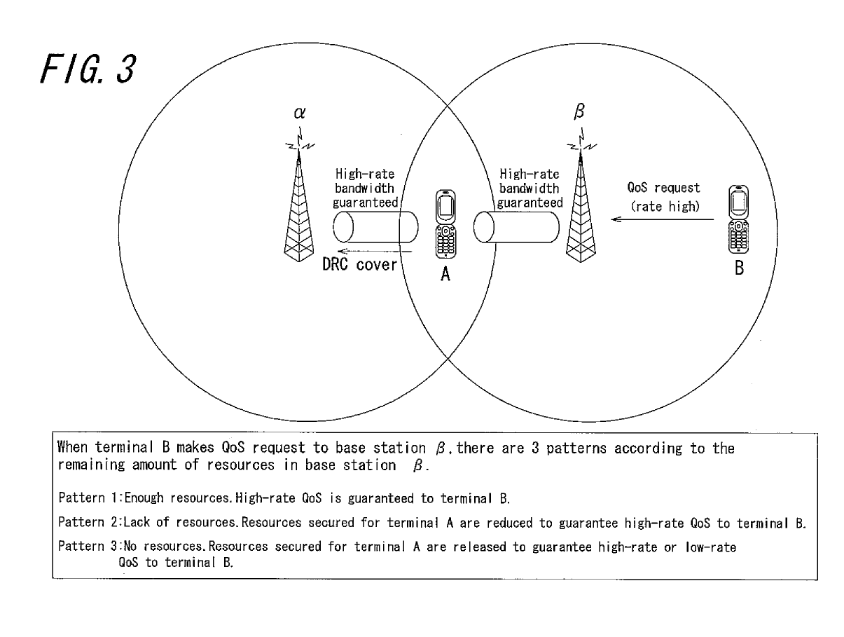

Next, the QoS control process performed by a base station, which is a communication control apparatus, in a mobile terminal communication system in accordance with the present embodiment is described based on FIGS. 3˜8. At first, an outline of the QoS control process including the QoS assignment process, QoS reduction process and QoS recovery process is described. As shown in FIG. 3, assuming that the wireless communication terminal B makes a new QoS request (rate high) to the base station β when the wireless communication terminal A which is communicating with the base station α at a high QoS rate is in the 2Way state with the base stations α and β, the QoS control process performed by the base station in this case can be classified into the following three patterns.

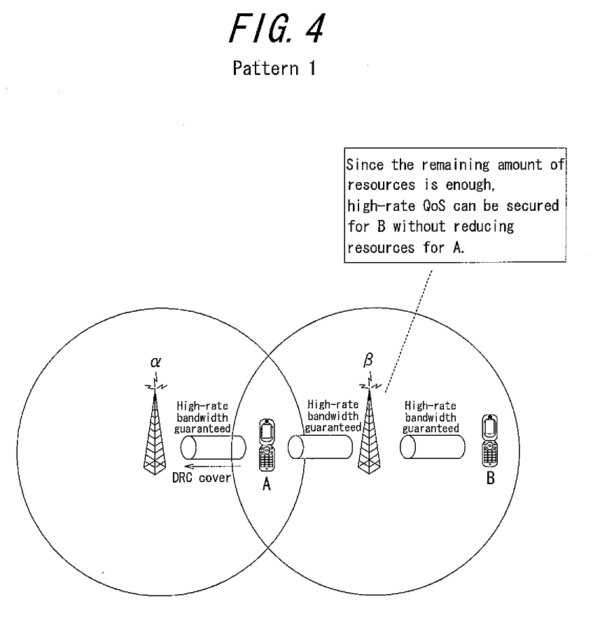

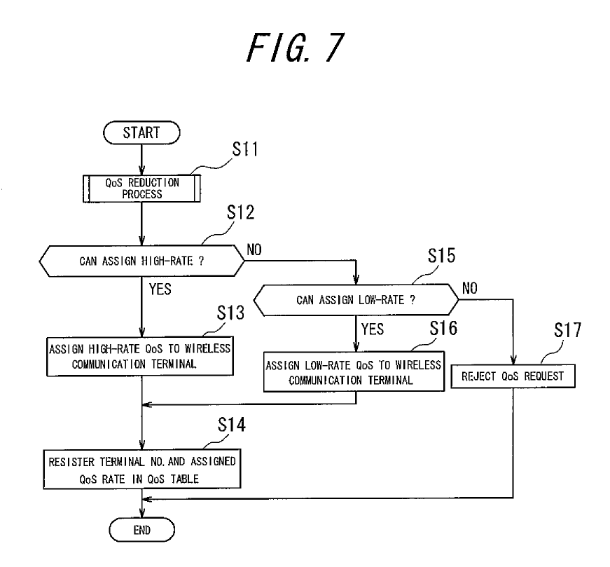

Pattern 1 shown in FIG. 4 illustrates the case where the remaining amount of QoS resources in the base station β is enough when the wireless communication terminal B makes a QoS request (rate high). In this case, since the remaining amount of QoS resources is enough, it is possible to assign a high rate QoS to the wireless communication terminal B without reducing the QoS resources for the wireless communication terminal A by executing step S13 following YES in step S12 after skipping the QoS reduction process in step S11 of the flow chart of FIG. 7 that shows the QoS assignment process performed by the base station β. Further, after step S13, the process moves to step S14 in which “a terminal No. and an assigned QoS rate” are registered in a QoS table.

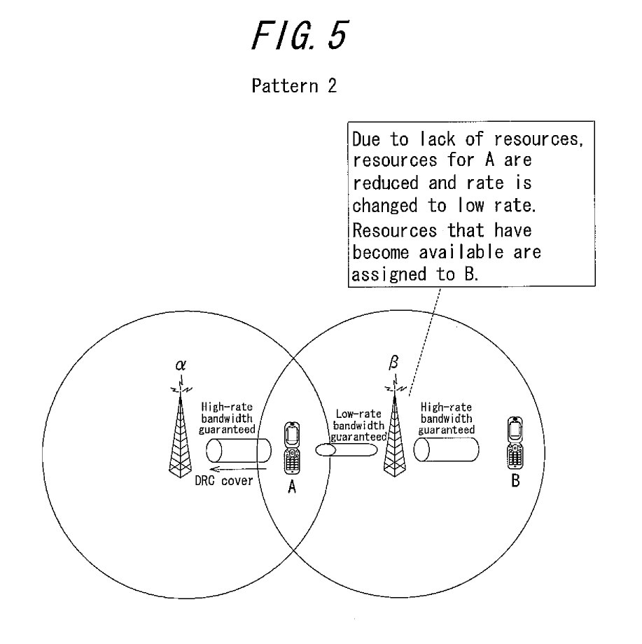

Pattern 2 shown in FIG. 5 illustrates the case when the wireless communication terminal B makes a QoS request (rate high), the remaining amount of QoS resources in the base station β is not enough to meet the QoS request (rate high) from the wireless communication terminal B, but can meet the QoS request (rate high) if the QoS resources for the wireless communication terminal A are eliminated. In this case, a high-rate QoS is assigned to the wireless communication terminal B by reducing the QoS resources that have been secured for the wireless communication terminal A by executing the QoS reduction process in step S11 of the flow chart of FIG. 7 so that the process moves from YES in step S12 to step S13.

Here, since the base station β performs the QoS reduction process internally, it is not required to notify the wireless communication terminal A which is in the 2Way state with the base stations α and β shown in FIG. 3 of the state where “the QoS resources for the wireless communication terminal A have been reduced by the base station β”. Therefore, the base station β does not transmit “a message indicating that the QoS resources for the wireless communication A have been reduced”. In addition, when QoS resources are reduced the QoS rate guaranteed for the wireless communication terminal is reduced. Thus the QoS rate before reduction for the wireless communication terminal whose QoS resources have been reduced is recorded in a QoS table.

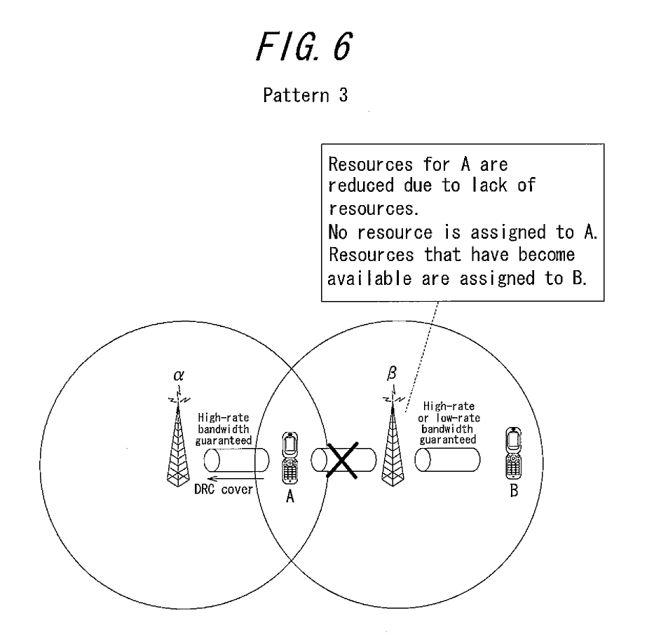

Pattern 3 shown in FIG. 6 illustrates the case where since QoS resources have been secured for the wireless communication terminal A with which the base station β is not communicating when the wireless communication terminal B makes the QoS request (rate high), the QoS resources in the base station β have decreased to the amount which is not enough to assign even a low-rate QoS in response to the QoS request from the wireless communication terminal B (that is, the case of no QoS resources). In this case, the QoS request from the wireless communication terminal B is rejected by executing step S17 following NO in step S15 following NO in step S12 unless the QoS reduction process in step S11 of the flow chart of FIG. 7 is executed. Therefore, the QoS reduction process in step S11 of the flow chart of FIG. 7 is executed so that the process moves from YES in step S12 to step S13 or the process moves to step S16 through NO in step S12 to YES in step S15. Thus all or a part of the QoS resources secured for the wireless communication terminal A are reduced, and the QoS resources are not assigned to the wireless communication terminal A. Therefore, a high-rate QoS or a low-rate QoS is assigned to the wireless communication terminal B by providing the wireless communication terminal B with the QoS resources that have become available.

[QoS Reduction Process]

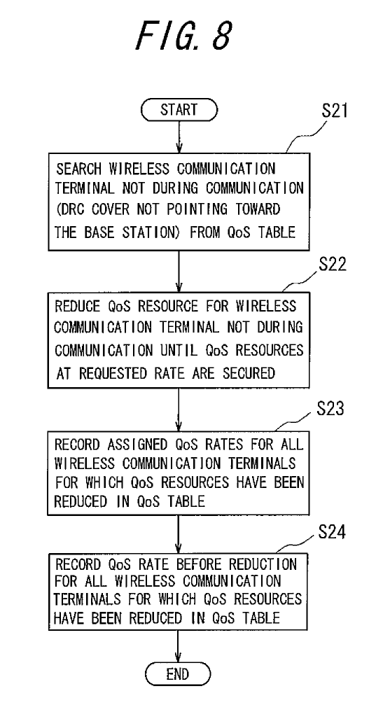

FIG. 8 is a flow chart showing the QoS reduction process performed by a base station, which is a communication control apparatus, in a mobile terminal communication system in accordance with the first embodiment. This QoS reduction process is activated based on a state where “a base station has received a new QoS request from another wireless communication terminal” as a trigger and is executed when two conditions such as “there is one or more wireless communication terminals that are in the 2Way state but are not connected to (do not communicate with) the base station” and “QoS resources in the base station are not enough when the new QoS request is received from another wireless communication terminal” are established.

At first, in step S21 of FIG. 8, wireless communication terminals that are not communicating with the base station (wireless communication terminal whose DRC Cover does not point toward the base station) are searched from the QoS tables stored in the QoS table memory unit 180a of the system memory unit 180. In the next step S22, the QoS resources for the wireless communication terminal (the wireless communication terminal A in the example of FIGS. 5 and 6) that is not communicating with the base station are reduced until the QoS resource amount requested by the wireless communication terminal B is secured. After that, in step S23, the assigned QoS rates for all of the wireless communication terminals whose QoS resources have been reduced are recorded in a QoS table, and in step S24, the QoS rates before reduction for all of the wireless communication terminals whose QoS resources have been reduced are recorded in the QoS table.

In the case of a QoS table exemplified in FIG. 2(b), with respect to the wireless communication terminal A, the QoS rate before reduction is “high” and the assigned QoS rate is “low”, which shows that the QoS resource has been reduced. On the other hand, with respect to the wireless communication terminal B, the QoS rate before reduction is “-(none)” and the assigned QoS rate is “high”, which shows that a high-rate QoS resource has been given.

[QoS Recovery Process 1; in the Case where QoS Resources Become Available]

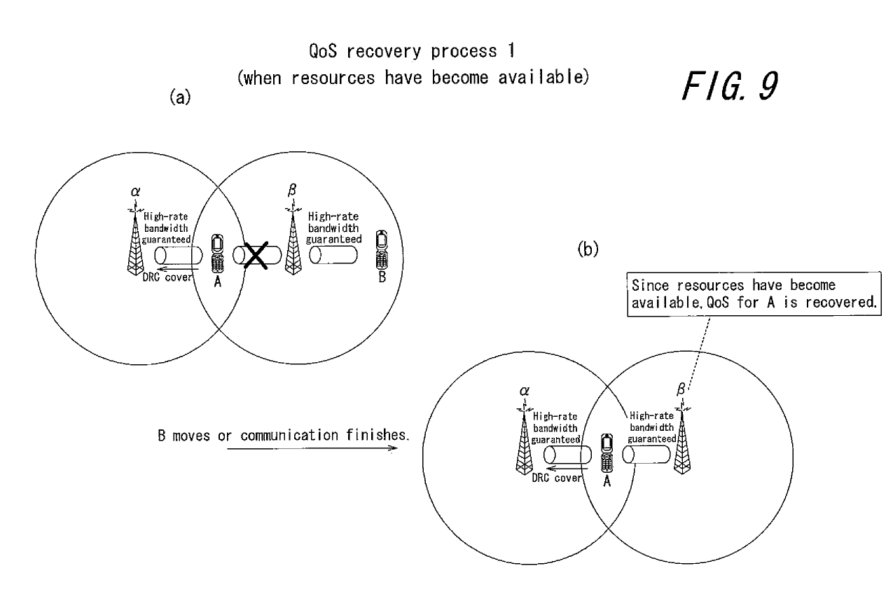

In the case where “the state where all of the QoS resources for the wireless communication terminal A have been eliminated” as shown in FIG. 9 (a) is caused by the above-mentioned QoS reduction process, it is preferable to recover the QoS resources for the wireless communication terminal A as shown in FIG. 9(b) in preparation for handoff by the wireless communication terminal A to the base station β, in order to speed up the process when the wireless communication terminal A actually performs handoff to the base station β. The QoS recovery process below is performed to the wireless communication terminals from which at least a part of QoS resources have been reduced by the above-mentioned QoS reduction process.

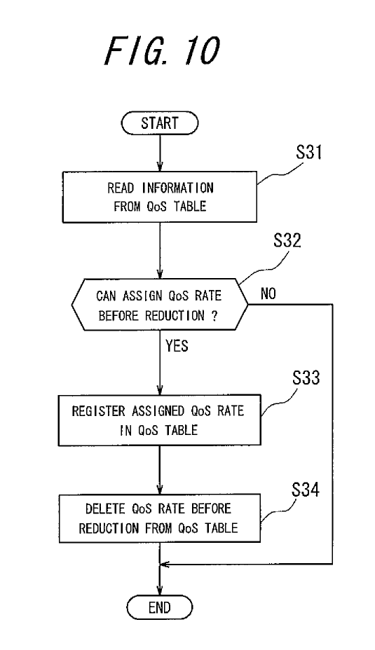

FIG. 10 is a flow chart showing the QoS recovery process 1 performed by a base station, which is a communication control apparatus, in a mobile terminal communication system in accordance with the first embodiment. This QoS recovery process 1 is activated based on the state where “the QoS resources in the base station β become available as shown in FIG. 9 (b)” as a trigger. As “the state where the QoS resources in the base station β become available”, the states where “the wireless communication terminal B has moved to outside the range of the base station β” and “the wireless communication terminal B has finished the communication with the base station β” are included.

At first, in step S31 of FIG. 10, the information relating to the wireless communication terminal A is read from a QoS table stored in the QoS table memory unit 180a of the system memory unit 180. In the next step S32, whether the QoS rate before reduction can be assigned or not is determined. Then if it can be assigned, the process moves to step S33 after assigning, and the assigned QoS rate which has actually been assigned is recorded (registered) in a QoS table. After that, the process moves to step S34 in which the QoS rate before reduction in the QoS table is deleted. By executing the above-mentioned processes, the QoS resources for the wireless communication terminal A are recovered to the state as that before elimination of QoS resources. In addition, in the case where the QoS rate before reduction is “high”, a “high” QoS rate is assigned by the process in the above-mentioned step S33. However, in the case where the QoS rate before reduction is “low”, if possible, a “high” QoS rate is assigned, and if it is not possible to assign a “high” QoS rate, a “low” QoS rate is assigned by the process in the above-mentioned step S33.

[QoS Recovery Process 2; in the Case where DRC Cover is Switched]

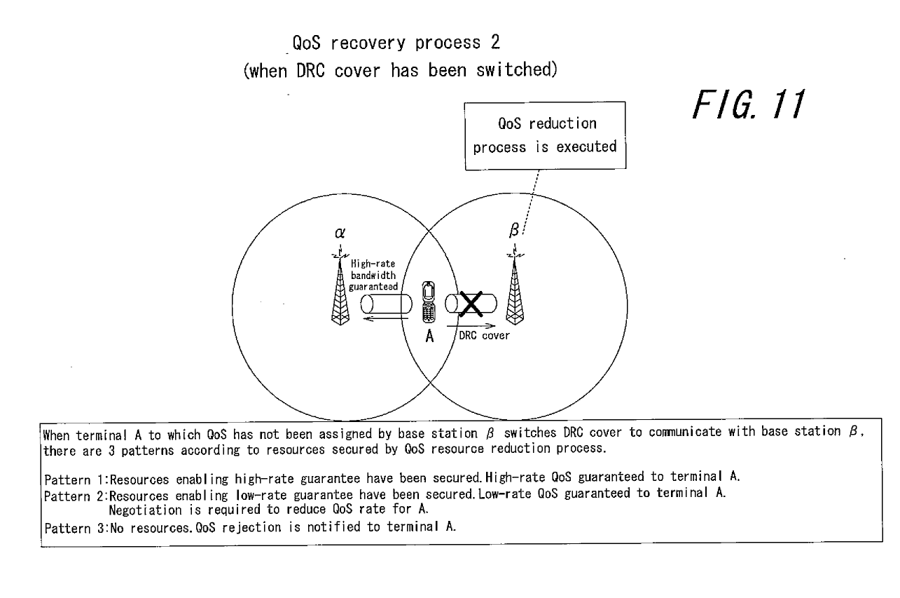

In the case where “the sate where all of the QoS resources for the wireless communication terminal A have been eliminated” as shown in FIG. 11 is caused by the above-mentioned QoS reduction process, if the DRC Cover which points toward the base station α is switched so that it points toward the base station β, it is indicated that the wireless communication terminal A attempts to perform handoff to the base station β. The processes (the QoS recovery process is included) the base station 3 performs in this case are classified into the following 3 patterns;

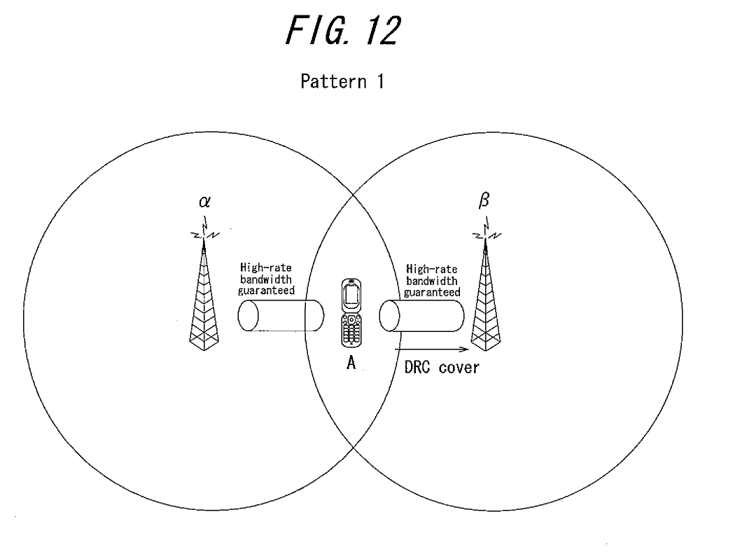

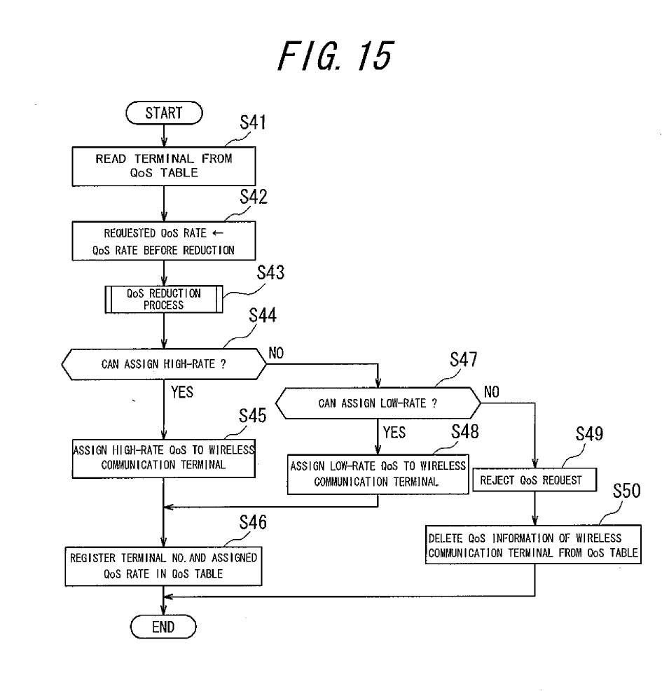

Pattern 1 shown in FIG. 12 illustrates the case where the remaining amount of the QoS resources in the base station β is enough when the wireless communication terminal A that is communicating with the base station α at a high QoS rate attempts to perform handoff to the base station β. In this case, the remaining amount of the QoS resources is enough with no need for performing the QoS reduction process for another wireless communication terminal (not shown in the case of FIG. 12) in the base station β. Therefore, a high-rate QoS can be assigned to the wireless communication terminal A by executing step S45 following YES in step S44 after skipping the QoS reduction process in step S43 following steps S41 and S42 of the flow chart of FIG. 15 showing the QoS recovery process 2 performed by the base station β. After step S45, the process moves to step S46, and “a terminal No. and an assigned QoS rate” are registered in a QoS table. Here, with respect to the wireless communication terminal A, a QoS rate does not change before and after the QoS recovery process (a high rate is maintained). Therefore, no “notice of QoS rate” is given to the wireless communication terminal A.

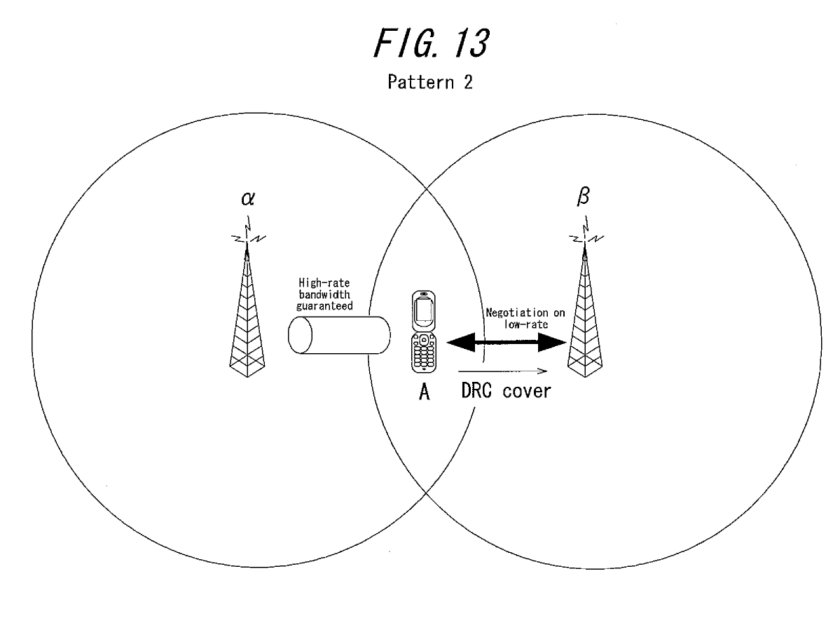

Pattern 2 shown in FIG. 13 illustrates the case where the remaining amount of the QoS resources in the base station β which has been recovered by performing the QoS reduction process for another wireless communication terminal cannot meet the QoS request (high rate) from the wireless communication terminal A, but can meet the QoS request (low rate) from the wireless communication terminal A when the wireless communication terminal A that is communicating with the base station α at a high QoS rate attempts to perform handoff to the base station β. In this case, in step S41 of the flow chart of FIG. 15, the information relating to the wireless communication terminal A is read from a QoS table stored in the QoS table memory unit 180a of the system memory unit 180, then in the next step S42, the QoS rate before elimination is determined as the requested QoS rate, and in the next step S43, the QoS reduction process for another wireless communication terminal is performed to recover the QoS resources in the base station β. Then in step S44, whether a high QoS rate can be assigned or not is determined as NO, and the process moves to step S47 in which whether a low QoS rate can be assigned or not is determined as YES, then the process moves to step S48, in which a low-rate QoS is assigned to the wireless communication terminal A. After step S48, the process moves to step S46, and “a terminal No. and an assigned QoS rate” are registered in a QoS table. However, in the case of pattern 2, it is required for the wireless communication terminal A that continues communication by performing handoff from the base station α to the base station β to conduct “a negotiation on a low QoS rate (notice of QoS rate)” with the base station β since the QoS rate changes from “high” to “low”.

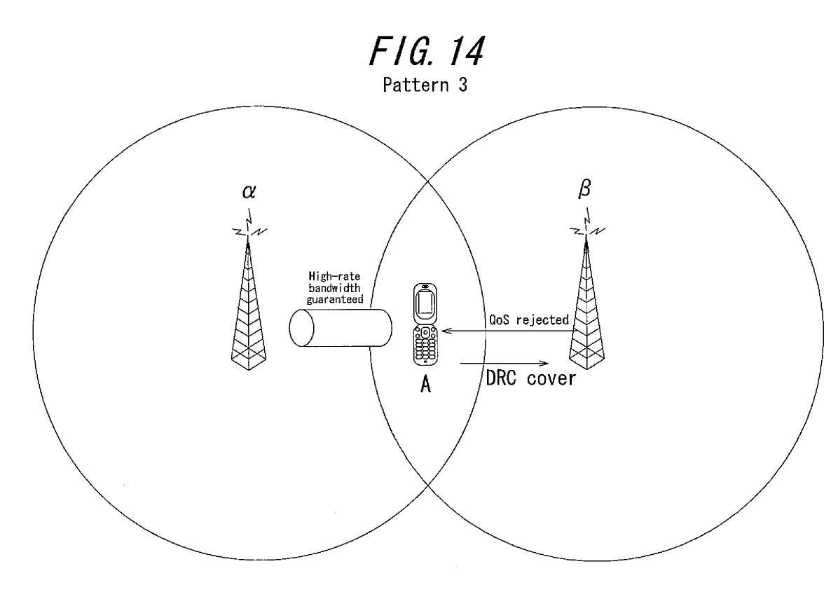

Pattern 3 shown in FIG. 14 illustrates the case where, although recovery of the QoS resources in the base station β is attempted by performing the QoS reduction process for another wireless communication terminal when the wireless communication terminal A that is communicating with the base station α at a high QoS rate attempts to perform handoff to the base station β, there is no another wireless communication terminal which can be a target of the QoS reduction process in the base station β and the QoS resources in the base station β cannot be recovered, and thus it is impossible to meet a QoS request (low rate) from the wireless communication terminal A.

In this case, in a flow chart of FIG. 15, the process moves from step S41-step S42-step S43-NO in step 44-NO in step S47 and to step S49 in which the QoS request from the wireless communication terminal A is rejected. Here, in the case of pattern 3, although the QoS recovery process for the wireless communication terminal A has been attempted, the QoS resources for the wireless communication terminal A have not been able to be recovered. Therefore, in the next step S50, the QoS information (QoS rate before reduction and assigned QoS rate) of the wireless communication terminal A is deleted from a QoS table. Here, the impossibility of assignment of the QoS resources is notified to the wireless communication terminal A. However, the communication of the wireless communication terminal A is continued by a non QoS guaranteed communication (e.g. Best Effort).

In accordance with the mobile terminal communication system of the present embodiment, a base station as a communication control apparatus determines whether a wireless communication terminal is actually communicating with the base station based on the DRC Cover or not and performs the QoS reduction process to reduce the QoS resources for a wireless communication terminal with which the base station is not actually communicating (reduction of all QoS resources, that is, no securement of QoS resources, is included), which makes it possible to provide QoS resources, to another wireless communication terminal which has transmitted a QoS request, that meet the QoS request (request for a high QoS rate), and further, to increase the accommodation number of the QoS communication terminals in the base station. Thus a communication control apparatus and a communication control method that can improve the use efficiency of QoS resources can be provided. Further, the above-mentioned QoS reduction process requires only internal process of a base station and there is no need for change on the wireless communication terminal side. Therefore, it has the advantage that there is no need for negotiation with the wireless communication terminal, message addition, and sequence change specified by the standard. Moreover, in accordance with the mobile terminal communication system of the present embodiment, since a base station as a communication control apparatus performs the QoS recovery process when the QoS resources become available or when a wireless communication terminal performs handoff to the base station to perform communication actually, when the QoS recovery process has been succeeded, it is possible to communicate at a secured original QoS rate or at a QoS rate that is lower than the secured original QoS rate. Thus it is possible to provide a communication control apparatus and a communication control method that can improve the use efficiency of QoS resources. In addition, since the above-mentioned QoS reduction process requires only internal process of a base station and there is no need for change on the wireless communication terminal side, there is no need for message addition and sequence change specified by the standard. Therefore, it has the advantage that there is no need for negotiation with a wireless communication terminal except the case where communication is performed at a QoS rate which is lower than the original QoS rate.

In the above-mentioned QoS control process including the QoS assignment process, QoS reduction process and QoS recovery process in accordance with the mobile terminal communication system of the first embodiment, handoff between base stations is exemplified. However, in the case where the cover area is divided into about three, for example, in the same base station and handoff is performed among these areas (handoff among sectors), it is also possible to perform the QoS control in accordance with the present invention in the same manner mentioned above by controlling the QoS resources by each sector.

1. A communication control apparatus comprising:
a resource assigning unit for receiving a QoS setting request and assigning QoS resources in response to the QoS setting request; and
a resource securing unit for securing, when a wireless communication terminal that is communicating with a base station by setting a QoS specifies a handoff candidate base station from the base station, the QoS resources by correlating to the wireless communication terminal, wherein
the resource assigning unit assigns, in the case where there are no QoS resources available when receiving the QoS setting request and assigning the QoS resources in response to the QoS setting request, the QoS resources that have been secured by the resource securing unit by correlating to the wireless communication terminal to a wireless communication terminal that has transmitted the QoS setting request.

2. The communication control apparatus according to claim 1, wherein the resource securing unit secures the QoS resources and assigns a traffic channel as well for the wireless communication terminal that has transmitted the QoS setting request, and does not give notification of information relating to the secured QoS resources thereto.

3. The communication control apparatus according to claim 1, wherein, when the QoS resources have become available, the resource securing unit secures the QoS resources again by correlating to the wireless communication terminal that is communicating.

4. The communication control apparatus according to claim 1, wherein, in the case where the QoS resources secured by the resource securing unit by correlating to the wireless communication terminal have been assigned to another wireless communication terminal when the wireless communication terminal having specified the handoff candidate base station initiates a handoff process;
the resource securing unit secures the QoS resources required for the wireless communication terminal to communicate by setting a QoS; and
the resource assigning unit assigns the QoS resources secured by the resource securing unit to the wireless communication terminal.

5. A communication control method, comprising the steps of;
securing QoS resources, when a wireless communication terminal that is communicating with a base station by setting a QoS specifies a handoff candidate base station from the base station, by correlating to the wireless communication terminal; and
assigning, in the case where there are no QoS resources available when a new QoS setting request is received after securing the QoS resources and the QoS resources are assigned in response to the QoS setting request, the QoS resources secured by correlating to the wireless communication terminal that has specified the handoff candidate base station to a wireless communication terminal that has transmitted the new QoS setting request.
